(19) United States
(12) Patent Application Publication
(10) Pub. No.: US 2026/0172804 A1
(43) Pub. Date: Jun. 18, 2026

(54) VEHICLE AND A METHOD FOR CONTROLLING THE SAME

(71) Applicants: HYUNDAI MOTOR COMPANY, Seoul (KR); KIA CORPORATION, Seoul (KR)

(72) Inventor: Su Hyeon Chae, Hwaseong-si (KR)

(73) Assignees: HYUNDAI MOTOR COMPANY, Seoul (KR); KIA CORPORATION, Seoul (KR)

(21) Appl. No.: 19/359,483

(22) Filed: Oct. 15, 2025

(30) Foreign Application Priority Data
Dec. 13, 2024 (KR) 10-2024-0186133

(51) Int. Cl. H04W 8/02; H04W 4/44; H04W 76/19; H04W 84/04; H04W 88/06

(52) U.S. Cl. CPC H04W 8/02; H04W 4/44; H04W 76/19; H04W 84/042; H04W 88/06

(57) ABSTRACT

A vehicle includes a communication unit configured to communicatively connect a vehicle to a communication network or a server. The vehicle further includes a memory configured to store a first communication network list including at least one communication network and a second communication network list including at least one communication network set to have a restricted communication connection to the vehicle. The vehicle further includes a processor configured to confirm a communication connection request for connection of the vehicle to a communication network and request a communication connection to a specific communication network based on the first communication network list when a predetermined communication condition is satisfied. The first communication network list is configured not to be included in the second communication network list by the processor or the server.

### CROSS-REFERENCE TO RELATED APPLICATION

This application claims priority to and the benefit of Korean Patent Application No. 10-2024-0186133, filed on Dec. 13, 2024, the disclosure of which is incorporated herein by reference in its entirety.

### BACKGROUND

### 1. Field of the Disclosure

Various embodiments of the present disclosure relate to technology for efficiently managing connection of a vehicle to a communication network in a roaming environment.

### 2. Discussion of Related Art

With recent developments in automobile technology, vehicles are evolving from simple means of transportation to connected cars. Connected cars support various services through various network connections. These services may be provided smoothly only when a vehicle is stably connected to a communication network. In particular, stable connection to a communication network becomes a critical challenge in roaming environments in which the vehicle moves across a national border or leaves a network of a communication service provider.

In roaming environments, connection to a communication network is performed based on a public land mobile network (PLMN) list stored in a SIM card. However, when connection failures repeatedly occur, a range of communication network selection may be reduced, or the network conditions that change from region to region may not be reflected, resulting in connection problems. These problems may lead to a decrease in the reliability/stability and service quality of the vehicle's communication.

Further, unlike mobile phones, vehicles lack flexibility in access to networks due to limitations when attempting to resolve a communication network connection failure or when initializing a selection range after a communication network connection failure occurs. This may have a serious impact, particularly when smooth communication is required, e.g., in emergency situations.

### SUMMARY OF THE DISCLOSURE

The present disclosure has been made to solve the aforementioned problems and is directed to minimizing communication network connection failures so that a vehicle can stably connect to a communication network even in a roaming environment and providing an optimal communication network connection environment by reflecting a real-time network state.

The problems to be solved by the present disclosure are not limited to the problems mentioned above. Other problems that are not mentioned should be clearly understood by those of ordinary skill in the art from the description below.

According to an aspect of the present disclosure, a vehicle includes a communication unit configured to communicatively connect a vehicle to a communication network or a server. The vehicle further includes a memory configured to store a first communication network list including at least one communication network and a second communication network list including at least another communication network configured to have a restricted communication connection to the vehicle. The vehicle further includes a processor configured to confirm a communication connection request for connection of the vehicle to a communication network and request a communication connection to a specific communication network based on the first communication network list and based on a predetermined communication condition being satisfied. The first communication network list is configured not to be included in the second communication network list by the processor or the server.

In an embodiment, the processor may be configured to transmit communication network information including location information of the vehicle to the server based on the vehicle being powered off.

In an embodiment, the processor may be configured to receive an updated first communication network list from the server based on the vehicle being powered off or based on the vehicle being powered on after the vehicle being powered off.

In an embodiment, the processor may be configured to transmit information on the specific communication network and location information of the vehicle to the server based on the communication connection to the specific communication network being successful.

In an embodiment, the second communication network list may include information on at least one communication network failing to establish a communication connection to the vehicle.

In an embodiment, the predetermined communication condition may include failure of the communication unit to establish a communication connection to a previously connected communication network of the vehicle.

In an embodiment, the predetermined communication condition may further include no communication network being previously connected.

In an embodiment, the predetermined communication condition may further include a priority of radio access technology (RAT) of the previously connected communication network being lower than that of RAT of the communication network included in the first communication network list.

In an embodiment, the memory may further store information on a previously connected communication network of the vehicle. The processor may be configured to sequentially request a communication connection between the vehicle and the previously connected communication network and request a communication connection to the communication network included in the first communication network list based on the communication connection failing.

In an embodiment, the memory may further store a list of public land mobile networks (PLMNs) available for each country. The processor may be configured to request a communication connection to a communication network not included in the second communication network list among communication networks included in the list of PLMNs based on the connection to the communication network included in the first communication network list failing.

In an embodiment of the present disclosure, a method for controlling connection of a vehicle to a communication network. The method includes confirming a communication connection request for connection of the vehicle to the communication network. The method includes requesting a communication connection of the vehicle to a specific communication network based on a first communication network list and based on a predetermined communication condition being satisfied. The first communication network list and a second communication network list are stored in a memory of the vehicle. The first communication network list includes at least one communication network and the second communication network list includes at least another communication network configured to have a restricted communication connection to the vehicle. The first communication network list is configured not to be included in the second communication network list based on a communication connection having failed between the vehicle and the communication network.

In an embodiment, the method may further include transmitting communication network information including location information of the vehicle to a server based on the vehicle being powered off.

In an embodiment, the method may further include receiving an updated first communication network list from a server based on the vehicle being powered off or based on the vehicle being powered on after the vehicle being powered off.

In an embodiment, the method may further include transmitting information on the specific communication network and location information of the vehicle to the server based on the communication connection to the specific communication network being successful.

In an embodiment, the predetermined communication condition may include at least one of the vehicle failing to establish a communication connection to the previously connected communication network, no communication network being previously connected, and a priority of RAT of the previously connected communication network being lower than that of RAT of the communication network included in the first communication network list.

According to another embodiment of the present disclosure, a server includes a communication unit. The server further includes a memory configured to store a first communication network list including at least one communication network. The server further includes a control unit configured to confirm, based on a communication to a vehicle being successful, receipt of communication network information and location information of the vehicle from the vehicle. The control unit is further configured to update the first communication network list based on the communication network information and the location information of the vehicle received from the vehicle, and communication network information stored in the memory. The control unit is further configured to include, in the first communication network list at least one communication network matching the vehicle in response to receiving a request for information on the first communication network list from the vehicle. The control unit is further configured to transmit the first communication network list to the vehicle.

In an embodiment, the control unit may be configured to confirm whether a location of the vehicle requesting the first communication network list is within a reference distance from a location corresponding to a prestored communication network. The control unit may be configured to include, in the first communication network list, the communication network corresponding to being within the reference distance. The control unit may be configured to transmit the first communication network list to the vehicle.

In an embodiment, the control unit may be configured to determine at least one of communication networks corresponding to being within the reference distance based on the communication network information received from the vehicle. The control unit may be configured to include, in the first communication network list, the determined communication network. The control unit may be configured to transmit the first communication network list to the vehicle.

In an embodiment, the control unit may be configured to determine the at least one communication network based on at least one of a SIM profile, modem hardware (HW) information, modem software (SW) information, and modem vehicle model information of the communication network in the communication network information received from the vehicle.

In an embodiment, the control unit may be configured to increase the reference distance when the location of the vehicle deviates from the location corresponding to the prestored communication network by the reference distance.

### BRIEF DESCRIPTION OF THE DRAWINGS

The above and other objects, features and advantages of the present disclosure should become more apparent to those of ordinary skill in the art by describing various embodiments thereof in detail with reference to the accompanying drawings, in which:

FIG. 1 is a diagram of a communication network connection control system according to an embodiment;

FIG. 2 is a configuration diagram of a vehicle according to an embodiment;

FIG. 3 is a configuration diagram of a server according to an embodiment;

FIG. 4 is a flowchart showing communication network connection control according to an embodiment;

FIG. 5 is a flowchart showing communication network connection control according to an embodiment;

FIGS. 6A-6C are illustrative diagrams illustrating content related to a communication network in a communication network connection control process according to an embodiment;

FIG. 7 is a flowchart showing communication network connection control according to an embodiment;

FIG. 8 is an illustrative diagram illustrating content related to the communication network in the communication network connection control process according to an embodiment;

FIG. 9 is a flowchart showing content of management of a first communication network list in a server according to an embodiment;

FIG. 10 is a flowchart showing content of management of the first communication network list in the server according to an embodiment;

FIG. 11 is a flowchart showing content of management of the first communication network list in the server according to an embodiment; and

FIG. 12 is an illustrative diagram of information that is used in a process of managing the first communication network list in the server according to an embodiment.

### DETAILED DESCRIPTION

Hereinafter, various embodiments of the present disclosure are described in detail with reference to the accompanying drawings.

However, the technical idea of the present disclosure is not limited to the few embodiments that are described below but may be implemented in various different forms. One or more of the components in the embodiments may be selectively combined or substituted and used within the scope of the technical idea of the present disclosure.

Further, terms (including technical and scientific terms) used in the embodiments of the present disclosure may be construed as having the same meaning as commonly understood by those of ordinary skill in the art to which the present disclosure belongs unless explicitly and specifically defined and described. Such terms as those defined in a generally used dictionary may be interpreted as having meanings consistent with the context of the relevant field of art and should not be interpreted to have ideal or overly formal meanings unless explicitly defined in the present disclosure.

In addition, the terms used in the embodiments of the present disclosure are intended to describe various embodiments and are not intended to limit the present disclosure.

In the present specification, a singular form may include a plural form unless the context clearly indicates otherwise. When “at least one (or one or more) of A, B, and C” is described, this may include one or more of all combinations of A, B, and C.

In addition, terms such as “first,” “second,” “A,” “B,” “(a),” and “(b)” may be used to describe components in the embodiments of the present disclosure.

These terms are only intended to distinguish the component from other components, and do not limit the nature, order, or sequence of the component.

When a component is described as being “connected,” “coupled,” or “joined” to another component, this may include not only a case where the component is directly connected, coupled, or joined to the other component, but also a case where the component is “connected,” “coupled,” or “joined” to the other component by still another component between the component and the other component.

Further, when one component is described as being formed or disposed “on or under” another component, the term “on or under” includes not only a case in which two components are in direct contact with each other, but also a case in which one or more other components are formed or disposed between the two components. In addition, when the term “on or under” is expressed, this may mean not only an upward direction but also a downward direction with respect to one component.

When a component, device, element, part, unit, module or the like of the present disclosure is described as having a purpose or performing an operation, function, or the like, the component, device, or element should be considered herein as being “configured to” meet that purpose or to perform that operation or function. For example, a “processor configured to (or set to) perform A, B, and C” may mean a dedicated processor (e.g., an embedded processor) for performing a corresponding operation or a specifically configured processor (e.g., a central processing unit (CPU) or an application processor) which performs corresponding operations by executing one or more software programs or computer-executable instructions which are stored in a memory. Each “part”, “unit”, “module”, “component”, “device”, “element”, and the like may separately embody or be included with a processor and a memory, such as a non-transitory computer readable media, as part of the apparatus.

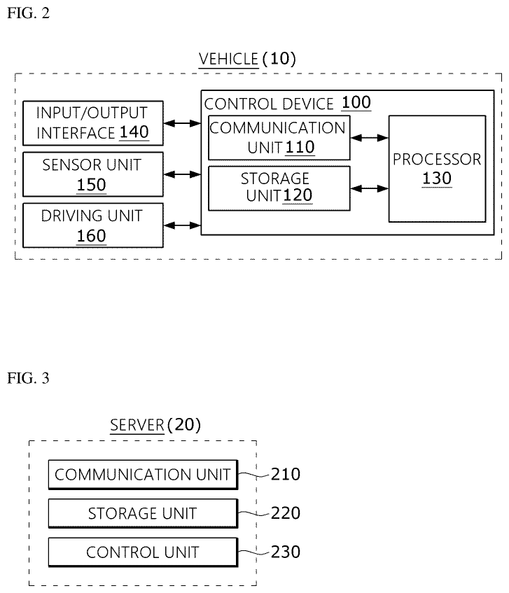

In various flowcharts of the present disclosure, at least some steps may be omitted or the order of the steps may be changed, and at least some of the various embodiments of the present disclosure may be performed at a specific point in time in each step of the flowchart. The various flowcharts of the present disclosure may be performed by at least one of a control device 100, a processor 130, or a vehicle 10 as shown in FIG. 2.

Hereinafter, embodiments of the present disclosure are described in detail with reference to the accompanying drawings. In the following drawings, the same reference numerals are used throughout to designate the same or equivalent elements, even though the elements are shown in different drawings and redundant descriptions thereof are omitted.

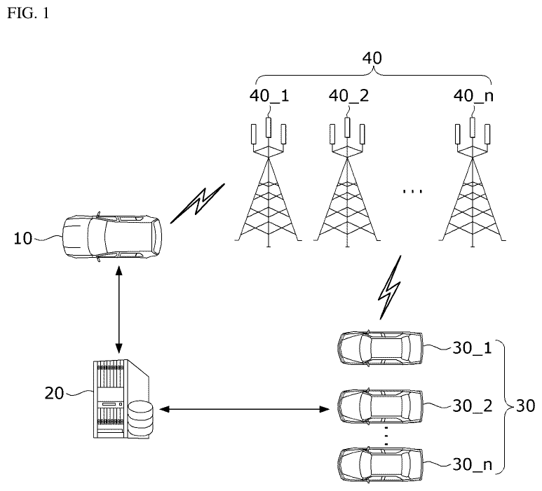

FIG. 1 is a diagram of a communication network connection control system according to an embodiment.

Referring to FIG. 1, the communication network connection control system may include a vehicle 10 and a server 20. The vehicle 10 may connect to one or more communication networks 40, e.g., communications networks 40_1, 40_2, . . . , and 40_n. The server 20 may perform communication with one or more other vehicles 30, e.g., vehicles 30_1, 30_2, . . . , and 30_n, in addition to the vehicle 10. The server may be disposed remote from the vehicle 10 and the vehicles 30.

The communication network connection control system may control the connection to the communication network with which the vehicle 10 can communicate in a roaming environment. Further, the communication network connection control system may provide the vehicle 10 with updated connection communication network information (for example, a first communication network list) through cooperation with the server 20 even in a situation in which the network connection of the vehicle 10 is restricted in a specific region, thereby supporting the vehicle 10 so that the vehicle 10 maintains minimum network connectivity in the roaming environment.

FIG. 2 is a configuration diagram of a vehicle 10 according to an embodiment.

The vehicle 10 may include a control device 100, a communication unit 110, a storage unit 120, a processor 130, an input/output interface 140, a sensor unit 150, and a driving unit 160. Each of these components of FIG. 2 may be implemented inside the vehicle 10.

The control device 100 may be formed integrally with internal components of the vehicle, may be implemented as an independent device separately from the other components inside the vehicle 10, and may perform communication with the internal components of the vehicle through various connection means (for example, a CAN bus, a wireless network, and a wired connection). The control device 100 may include the communication unit 110, the storage unit 120, and the processor 130 to control the vehicle, and may further include other components such as the input/output interface 140, the sensor unit 150, and the driving unit 160. The control device 100, the communication unit 110, the input/output interface 140, the sensor unit 150, and the driving unit 160 may be implemented by one or more processors such as the processor 130. The storage unit 120 may include a non-transitory memory.

According to an embodiment, the control device 100 may manage the communication connection state of the vehicle 10 and perform various functions for optimizing communication network connection in the roaming environment.

According to an embodiment, the control device 100 may confirm the first communication network list stored in the storage unit 120 when the vehicle 10 is powered on. The control device 100 may attempt to connect to the communication network through the communication unit 110 based on the previously connected communication network information of the vehicle 10, the first communication network list, or the PLMN list.

Further, the control device 100 may be configured to receive an updated first communication network list from the server 20 through the communication unit 110. The control device 100 may update the updated first communication network list in the storage unit 120 so that the updated first communication network list can be utilized when the communication network is connected.

Further, the control device 100 may include logic for registering the communication network information as a forbidden PLMN (FPLMN) list (for example, a second communication network list) in the storage unit 120 when the vehicle fails to connect to the communication network, and reattempts to connect to another communication network included in the PLMN list.

Further, the control device 100 may be configured to register the corresponding communication network information in the second communication network list in the storage unit 120 when the vehicle 10 fails to connect to the communication network, but the communication network included in the first communication network list is not included in the second communication network list.

The communication unit 110 may perform communication with other control devices inside the vehicle to share inter-system data or transmit or receive various types of information through a connection to the outside of the vehicle. The communication unit 110 may transmit control signals and data between the internal components using various in-vehicle communication schemes such as CAN communication and Ethernet. The communication unit 110 may link driving information and external data in real time through communication with a user terminal, another vehicle (vehicle-to-vehicle (V2V)), infrastructure (vehicle-to-infrastructure (V2I)), or an external server.

The communication unit 110 may perform short-range communication, GPS signal reception, vehicle-to-everything (V2X) communication, optical communication, broadcast transmission and reception, and intelligent transport systems (ITS) communication functions, and may support stable data transmission in a short range using wireless communication technology such as Bluetooth, radio frequency identification (RFID), Infrared Data Association (IrDA), ultra wideband (UWB), ZigBee, near field communication (NFC), Wi-Fi, Wi-Fi Direct, and wireless USB. Further, the communication unit 110 may include a mobile communication module based on a mobile communication network (2G, 3G, 4G, 5G, or the like) and a wireless Internet module for connection to wireless Internet to receive real-time data through long-range communication and manage a communication state of the vehicle 10 or update latest data in conjunction with a cloud.

The storage unit 120 may include various types of memories capable of storing data. The storage unit 120 may be integrated into the control device 100 or the processor 130 or configured in the form of a separate module. The storage unit 120 may include a nonvolatile memory (for example, a hard disk drive, a flash memory, an EEPROM, an SRAM, an FRAM, a PRAM, or an MRAM) and a volatile memory (for example, a DRAM, an SDRAM, or a DDR-SDRAM), which may be combined to implement memory systems with various capacities and performances.

According to an embodiment, the storage unit 120 may include a home communication network list. The home communication network list is based on communication network information defined in a subscriber identity module (SIM) profile of the vehicle 10. The home communication list may allow a communication network to which the vehicle can basically attempt to connect to be identified. This home communication network list may be a home network set so that a vehicle 10 transported to a specific country selects a network associated with a specific mobile carrier of the country.

Further, the storage unit 120 may include the first communication network list. The first communication network list includes the latest communication network information received from the server 20 and is designed so that the vehicle 10 can maintain a minimum communication connection even in the roaming environment. The first communication network list may be updated in the server 20 based on the communication network information that is received from the vehicle 10 or the other vehicle 30 and accumulated.

According to an embodiment, the storage unit 120 may include the public land mobile network (PLMN) list. The PLMN list may be a communication network list predefined in the SIM profile of the vehicle 10, a public mobile communication network, and a network that provides a mobile communication services in a specific region. The PLMN list may be generally uniquely identified for each country or operator. The PLMN list may include priority-based network information that is referred to when the vehicle 10 attempts to connect to the communication network.

According to an embodiment, the storage unit 120 may include the second communication network list. The second communication network list may be a forbidden public land mobile network (FPLMN) list. In other words, the FPLMN list may include information on a communication network to which the vehicle 10 has attempted to connect, but the connection has been denied.

The second communication network list may be designed to exclude networks with a low likelihood of success even when the vehicle 10 repeatedly attempts to connect to the networks, thereby preventing unnecessary time consumption and saving resources during the process of searching for and connecting to the communication network. For example, a communication network whose network state is unstable in a specific region or which is not compatible with the SIM profile may be registered in the second communication network list when the connection is denied.

Further, the second communication network list stored in the storage unit 120 is managed by the control device 100. The second communication network list may be initialized or updated as needed. However, in an embodiment of the present disclosure, the second communication network list may be set so that the communication network information included in the first communication network list is not registered, making it possible for the vehicle 10 to always maintain a network to which the vehicle 10 can connect. Accordingly, the vehicle 10 can have a high communication network connection success rate and maintain a stable network connection even in the roaming environment.

The processor 130 may perform communication with the communication unit 110, the storage unit 120, the input/output interface 140, the sensor unit 150, the driving unit 160, and various internal components of the vehicle 10 through electrical or operational connections. The processor 130 may control an operation of each component and perform data processing. The processor 130 may be a central processing unit for command execution and data calculation, and may collect, process, and analyze data in real time to perform vehicle control according to a driving environment of the vehicle.

The processor 130 may be implemented in the form of hardware, software, or a combination thereof, and may perform vehicle control logic in the form of, for example, a microcontroller, an FPGA, or an ASIC.

The input/output interface 140 serves to receive input related to vehicle control from the user and transfer a vehicle control status and system operation information to the user.

The input/output interface 140 may perform a function of receiving various inputs from the user and transferring the vehicle control status to the user. The input/output interface 140 may include hardware to receive input data and to output data.

The sensor unit 150 may include a plurality of sensors that detect various types of driving and environmental information in real time to support stable operation of an autonomous driving and driver assistance system. The sensor unit 150 may measure a distance to and speed of a nearby object through long-range detection sensors such as radio detection and ranging (RADAR) and light detection and ranging (LiDAR). The sensor unit 150 may detect objects near the vehicle 10 by including an ultrasonic sensor. Further, the sensor unit 150 may include a camera.

The driving unit 160 may include various components that provide drive power required for driving of the vehicle 10 and control the operation of the vehicle according to a command output from the control device 100. The driving unit 160 may be configured of devices that generate and transfer power for the vehicle, such as an engine, a motor, a transmission, and a wheel drive system, and a controller that controls the devices. Acceleration, deceleration, and direction change of the vehicle 10 may be performed via the components of the driving unit 160.

FIG. 3 is a configuration diagram of the server according to an embodiment.

The server 20 may include a communication unit 210, a storage unit 220, and a control unit 230. Although not shown, the server 20 may further include an input/output interface for mutual interaction with an administrator. The communication unit 210 and the control unit 230 may be implemented by a processor of the server 20. The storage unit 220 may include a non-transitory memory.

The communication unit 210 of the server 20 is responsible for data transmission and reception between the server 20 and the vehicle 10. The communication unit 210 may provide a stable network connection through various communication technologies. The communication unit 210 may support short-range communication technologies (Wi-Fi, Bluetooth, ZigBee, and the like). The communication unit 210 may include a mobile communication module based on a mobile communication network (2G, 3G, 4G, 5G, or the like) and a wireless Internet module for connection to wireless Internet to receive real-time data through long-range communication and to be linked to a cloud.

Further, the communication unit 210 may connect to the vehicles 30 and an external cloud system to support V2V, V2I, and vehicle-to-cloud (V2C).

The storage unit 220 of the server 20 may include various types of memories that can store and manage data collected through communication with the vehicle 10 or the other vehicle 30. The storage unit 220 may be configured by combining a nonvolatile memory (for example, a flash memory, HDD, or SSD) with a volatile memory (for example, a DRAM or SDRAM), and may include a cloud-based distributed storage system for large-scale big data processing and storage.

The storage unit 220 may accumulate and store various types of communication network information received from the vehicle 10 and the other vehicle 30s. The storage unit 220 may perform big data analysis or a predetermined algorithm based on the communication network information to update the first communication network list. The storage unit 220 may continuously collect and manage various types of data such as location information, communication network connection history, communication quality data (RSRP, SNR, or the like), a connection success rate, and a network congestion state.

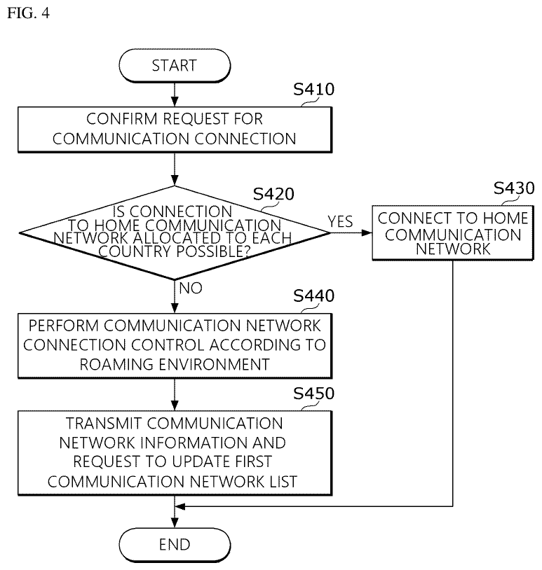

FIG. 4 is a flowchart showing communication network connection control according to an embodiment.

The control device 100 may confirm a request for communication connection of the vehicle 10 (S410).

For example, when the control device 100 detects that the vehicle 10 is powered on, the control device 100 may confirm the communication network information stored in the storage unit 120 or the communication state of the communication unit 110 of the vehicle 10 to confirm whether a communication connection is required.

The control device 100 may confirm whether a connection to a home communication network allocated to each country is possible (S420). The home communication network is confirmed based on a network to which the vehicle is able to connect, which is defined in the SIM profile of the vehicle 10, by referring to the home communication network list stored in the storage unit 120.

When home communication network connection is possible (YES in S420), the control device 100 may attempt to connect to the home communication network through the communication unit 110 (S430). Specifically, the control device 100 may perform a connection request by utilizing the network information selected from the home communication network list stored in the storage unit 120, and continuously monitor the communication state when the connection is successful, thereby maintaining a stable network connection.

When the home communication network connection is not possible (NO in S420), the control device 100 may perform communication network connection control according to the roaming environment (S440).

For example, the control device 100 may confirm at least one of the previously connected communication network information to be described later, the first communication network list, the PLMN list, and the second communication network list, to search for another available communication network or apply an appropriate connection logic so that connection failure does not occur.

When the communication connection is successful in the roaming environment or after the vehicle 10 is powered off, i.e., after the vehicle 10 is turned off, the control device 100 may transmit current location information and the communication network connection state information of the vehicle 10 to the server 20 (S450), thereby providing information so that the server 20 can manage and update the first communication network list. For example, when the communication connection is successful, the control device 100 may transmit connected communication network information, a connection time, and location information of the vehicle 10 to the server 20.

Further, after the vehicle 10 is powered off, the control device 100 may transmit the communication network information such as last communication network connection information and communication failure history, and the location information of the vehicle 10 to the server 20, and the server 20 may update the first communication network list based on the communication network information.

Through this process, the server 20 may comprehensively analyze communication network data collected from the vehicle 10 and the other vehicles 30 in the roaming environment. The server 20 may maintain and manage the first communication network list so that the vehicle 10 can be connected to the optimal communication network later.

In some embodiments, a request to update the first communication network list may be made before the vehicle 10 enters a sleep state after the vehicle 10 is powered off. Specifically, the control device 100 may detect a point in time when the vehicle 10 is powered off and perform the request to update the first communication network list by transmitting the current location information, the last communication network connection information, a communication network connection failure history, and the like to the server 20.

Further, the update of the first communication network list may be performed even after the vehicle is powered on. For example, when the vehicle 10 moves to a new region and a network environment changes, the control device 100 may receive the updated first communication network list from the server 20 and update the first communication network list in the storage unit 120.

Thus, the update of the first communication network list may be performed several times before the vehicle enters the sleep state after the vehicle is powered off, after the vehicle is powered on, and after the vehicle is powered off and on.

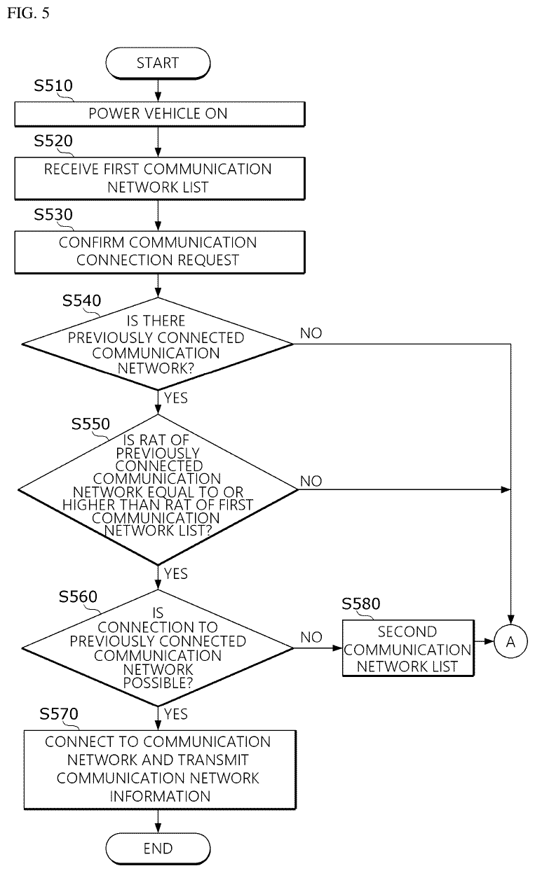

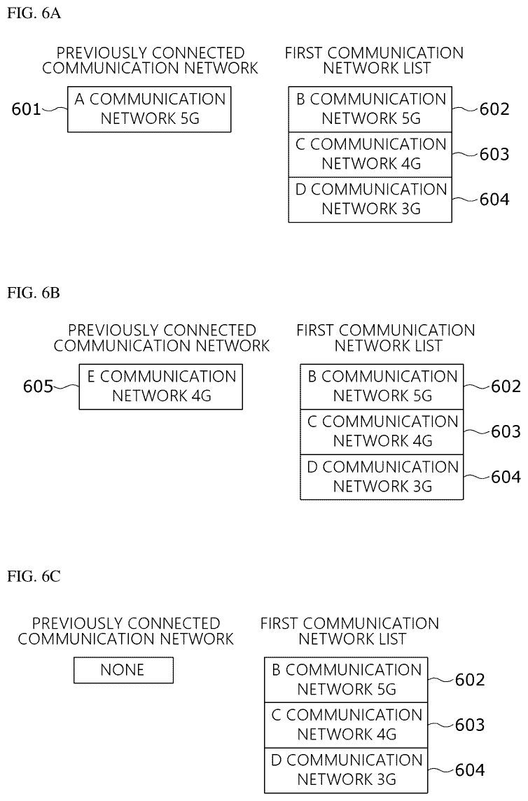

FIG. 5 is a flowchart showing communication network connection control according to an embodiment. Each step of FIG. 5 may be performed in the roaming environment in FIG. 4 described above, i.e., a case in which the vehicle does not connect to the home communication network. Further, for the description of FIG. 5, reference is made to FIGS. 6A-6C. FIGS. 6A-6C are illustrative diagrams showing content related to the communication network in a communication network connection control process according to an embodiment.

The control device 100 may detect that the vehicle 10 is powered on (S510).

For example, when the vehicle 10 is powered on, the control device 100 may confirm a communication connection request and start preparing for a network connection.

Alternatively, the control device 100 may also detect that the vehicle 10 is powered on. For example, when the vehicle is powered on, the control device 100 may confirm a network connection state of the vehicle and perform a communication network connection procedure.

The control device 100 may receive the first communication network list from the server 20 (S520). However, as described above, the first communication network list may be updated due to an update request performed before the vehicle 10 enters a sleep state after the vehicle 10 is powered off.

The control device 100 may confirm a communication connection request for the vehicle 10 (S530). When the communication connection request is received, the control device 100 may confirm whether there is a previously connected communication network of the vehicle 10 (S540).

The previously connected communication network information may be confirmed through a previous communication history or connected network information recorded in the storage unit 120.

In an embodiment, referring to FIG. 6A, the previously connected communication network information of the vehicle 10 and the first communication network list received from the server 20 are shown together. The previously connected communication network includes an A communication network 601 with a 5G radio access technology (RAT) version, and the first communication network list includes communication networks 602, 603, and 604 with various RAT versions such as 5G, 4G, or 3G. Using this information, the control device 100 may compare a state of the previously connected communication network with the first communication network list to perform a communication connection procedure.

Further, referring to FIG. 6C, in an embodiment, a case in which there is no previously connected communication network of the vehicle 10 is illustrated. In particular, FIG. 6C shows a state in which the vehicle 10 has no communication network connection history, and may include, for example, a case in which the previously connected communication network information recorded in the storage unit 120 has been deleted when the vehicle 10 first drives or when the vehicle does not drive or connect to a communication network for a long period of time.

When there is a previously connected communication network (YES in S540), the control device 100 may confirm whether a RAT version of the previously connected communication network is the same as or higher than those of the communication networks included in the first communication network list (S550).

Therefore, the control device 100 may determine whether the previously connected communication network provides an efficient and stable connection in a current network environment.

For example, referring to FIG. 6A, the first communication network list may include a B communication network 602 with a 5G RAT version, a C communication network 603 with a 4G RAT version, and a D communication network 604 with a 3G RAT version. In this case, when the RAT of the A communication network, which is the previously connected communication network, is 5G, the RAT of the A communication network may be evaluated as having a RAT version that is the same as or higher than those of all the communication networks included in the first communication network list.

Therefore, when the RAT version of the previously connected communication network is the same as or higher than those of the communication networks in the first communication network list, the control device 100 may regard the A communication network as a communication connection target and confirm a likelihood of connection to the A communication network in a subsequent step to attempt a communication connection.

When the RAT version of the previously connected communication network is the same as or higher than the RAT version of the first communication network list (YES in S550), the control device 100 may confirm whether a communication connection to the previously connected communication network is actually possible (S560). This is a step of determining whether the previously connected communication network is a valid network that is connectable to the vehicle 10 at a current physical location or in a current network state.

For example, the control device 100 may evaluate whether a connection to the previously connected communication network is possible based on a signal strength (RSRP), signal-to-noise ratio (SNR), or network congestion state of the previously connected communication network. This evaluation allows confirmation as to whether the previously connected communication network can support stable data transmission.

When the communication connection to the previously connected communication network is possible (YES in S560), the control device 100 may attempt to connect to the previously connected communication network through the communication unit 110. The control device 100 may transmit the communication network information to the server 20 when the connection is successful (S570).

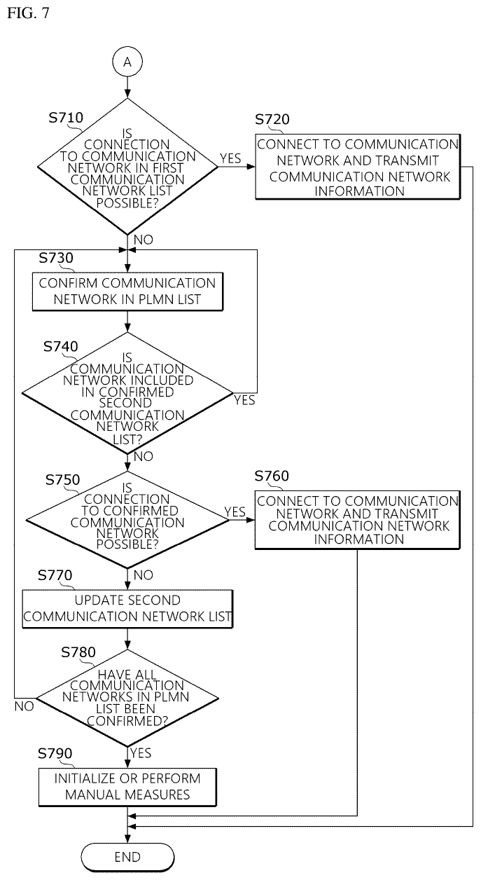

On the other hand, when there is no previously connected communication network (NO in S540), when the RAT version of the previously connected communication network is lower than the RAT version of the first communication network list (NO in S550), and when the communication connection to the previously connected communication network is not possible (NO in S560), the control device 100 may attempt to connect to the communication network based on the first communication network list as illustrated in FIG. 7, which is described below.

For example, referring to FIG. 6B, the previously connected communication network includes an E communication network 605 with a RAT version of 4G, and the first communication network list includes the B communication network 602 with the RAT version of 5G. In this case, since the RAT version of the E communication network that is the previously connected communication network is lower, the control device 100 skips an attempt to connect to the E communication network. The control device 100 attempts to connect to the B communication network 602 by referring to the first communication network list through a process of FIG. 7 described below.

Further, when the communication connection to the previously connected communication network is not possible (NO in S560), the control device 100 may update the second communication network list (S580). For example, the control device 100 may include the previously connected communication network to which the vehicle has failed to connect, in the second communication network list. This can minimize unnecessary communication network search attempts in the future.

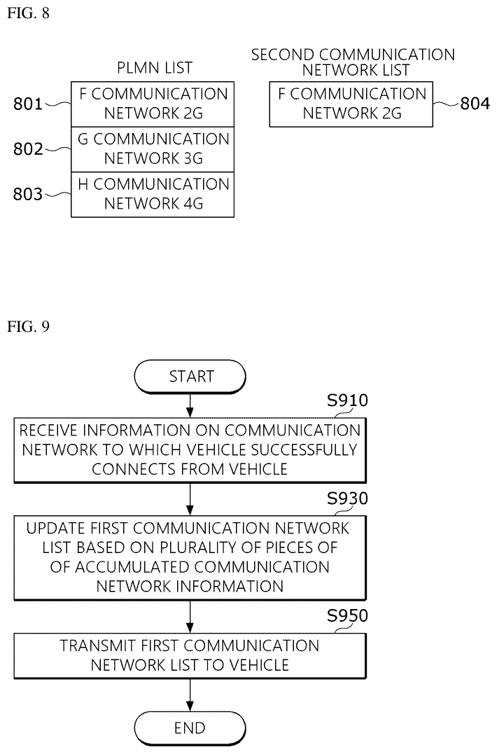

FIG. 7 is a flowchart showing communication network connection control according to an embodiment. FIG. 7 discloses an operation when the predetermined communication condition in FIG. 5 is satisfied. In other words, when there is no previously connected communication network in S540 of FIG. 5 or a RAT priority of the previously connected communication network is lower than that of the communication network included in the first communication network list in S550, or when the communication connection to the previously connected communication network fails in S560, the control device 100 may determine that the predetermined communication condition is satisfied. For the description of FIG. 7, reference is made to FIG. 8. FIG. 8 is an illustrative diagram illustrating the content related to a communication network in a communication network connection control process according to an embodiment.

The control device 100 may confirm whether the vehicle 10 is connectable to the communication network included in the first communication network list based on the first communication network list (S710). Specifically, the control device 100 may sequentially confirm the communication networks with a higher priority in the first communication network list stored in the storage unit 120 and determine whether the vehicle 10 is connectable to each communication network.

When at least one of the communication networks included in the first communication network list is determined to be available for connection (YES in S710), the control device 100 attempts to connect to such a communication network through the communication unit 110. When the connection is successful, the control device 100 transmits that determination to the server 20 to transmit the communication network information to the server (S720).

When there is no available communication network in the first communication network list (NO in S710), the control device 100 may confirm the communication network included in the PLMN list (S730).

For example, the control device 100 may sequentially confirm the communication networks included in the PLMN list through operations S730-S780 by referring to the PLMN list stored in the storage unit 120. The PLMN list includes communication network information defined in advance in the SIM profile of the vehicle 10, and may include the radio access technology (RAT), communication network identification information (for example, PLMN ID), and priority information of each communication network.

The control device 100 may confirm the first communication network or a communication network set to be searched in the PLMN list and confirm whether the communication network is included in the second communication network list (S740). The second communication network list includes information on communication networks that the vehicle 10 has previously attempted to connect but has failed and is used as a criterion for reducing unnecessary attempts to connect to communication networks with a low likelihood of successful connection.

For example, referring to FIG. 8, the PLMN list may include an F communication network 801 with a 2G RAT version, a G communication network 802 with a 3G RAT version, and an H communication network 803 with a 4G RAT version. Since the second communication network list includes an F communication network 804 that is the same as the F communication network 801, the F communication network 801 is identified as a communication network to which the connection has previously failed. Therefore, the control device 100 may skip the connection to the F communication network 801 confirmed in the PLMN list and confirm the G communication network 802, which is a communication network with the next priority that is not stored in the second communication network list.

The control device 100 may confirm a likelihood of connection to the confirmed communication network (S750). For example, the control device 100 may confirm whether the G communication network 802 can communicatively connect to the vehicle 10, as illustrated in FIG. 8.

When the connection to the confirmed communication network is possible (YES in S750), the control device 100 may attempt to connect to the communication network through the communication unit 110, and transmit corresponding communication network information to the server 20 so that the communication state can be updated, when the connection is successful (S760).

On the other hand, when the connection to the confirmed communication network fails (NO in S750), the control device 100 may additionally update the corresponding communication network information in the second communication network list (S770).

The control device 100 may determine whether all the communication networks in the PLMN list have been confirmed (S780). When there is a communication network that has not yet been confirmed among the communication networks included in the PLMN list (NO in S780), the control device 100 may branch to operation S730 to confirm the communication network with the next priority in the PLMN list, and then repeat the operations S740-S770.

When all the communication networks in the PLMN list are confirmed and a determination is made that there are no more available communication networks (YES in S780), the control device 100 may regard a likelihood of automatic connection as having ended. In this case, the communication connection state of the vehicle 10 may be initialized, or a user may perform manual measures (for example, manual network selection or SIM profile change) (S790). To this end, the control device 100 may output a notification indicating that all the communication networks in the PLMN list are confirmed and a determination is made that there are no more available communication networks, through the input/output interface 140.

In the control process of FIG. 7, when the communication network of the PLMN list fails in connecting, the control device 100 includes the communication network in the second communication network list (S770). However, when the communication network in the first communication network list fails connecting, the control device 100 does not include the communication network in the second communication network list. This is because the communication networks in the first communication network list are communication networks that are set to maintain a minimum network connection even in the roaming environment based on updated information, and thus it may be difficult to ensure a stable network connection when such communication networks are excluded.

In summary, regarding FIGS. 4-8 described above, when the control device 100 confirms a communication connection request of the vehicle 10 in the roaming environment, the control device 100 attempts to establish a communication connection in the following order.

Firstly, when there is the previously connected communication network of the vehicle 10, the control device 100 confirms the previously connected communication network and requests a communication connection. The control device 100 evaluates a connection state and RAT level of the previously connected communication network. The control device attempts to connect to the communication network when the communication network is at a level that is the same as or higher than the communication network included in the first communication network list.

Secondly, when the connection to the previously connected communication network is not possible or there is no previously connected communication network, the control device 100 attempts to connect based on the communication network included in the first communication network list. The first communication network list is the latest data received from the server 20 and is designed so that the vehicle 10 may maintain a minimum network connection. The control device 100 sequentially confirms the respective communication networks in the first communication network list to determine whether the connection is possible and attempts to connect to the available communication network.

Thirdly, when there is no available communication network in the first communication network list, the control device 100 requests communication network connection by referring to the PLMN list stored in the storage unit 120. In this case, the control device 100 may attempt to connect to the communication networks included in the PLMN list excluding those included in the second communication network list (communication networks with a history of previous connection failure). This minimizes unnecessary connection attempts and enables efficient communication network search.

This step-by-step communication connection logic enables the vehicle 10 to maintain a stable and efficient communication connection even in the roaming environment and minimizes communication failures due to network connection failures.

Hereinafter, the content of managing the first communication network list through the server 20 is described.

FIG. 9 is a flowchart showing content of managing the first communication network list in the server according to an embodiment.

The control unit 230 of the server 20 may receive the communication network information on the communication network to which the vehicle 10 successfully connects from the vehicle 10 (S910). For example, when the vehicle 10 successfully connects to a specific communication network, the communication network information, i.e., information including data such as identification information (PLMN ID), RAT, a connection quality indicator (for example, reference signal received power (RSRP) or signal-to-noise ratio (SNR)), location information, and connection time may be transmitted to the server 20. This information provides basic data that may reflect a communication environment and network state of the vehicle 10 in real time.

The control unit 230 may update the first communication network list based on a plurality of pieces of accumulated communication network information (S930).

Specifically, the control unit 230 may update the first communication network list based on the information on the communication network received from the vehicle 10, the location information of the vehicle 10, and the information on the communication network accumulated in the memory. In this case, the information on the communication network accumulated in the memory may include communication network information collected from not only the vehicle 10 but also the other vehicles 30 in a corresponding country or region.

Specifically, the control unit 230 may analyze the communication network data accumulated in the memory, including the communication network information and location information received from the vehicle 10, to update the first communication network list. The communication network information received from the vehicle 10 may include data such as a PLMN ID (communication network identifier), RAT, a connection quality indicator (for example, RSRP or SNR), a connection success rate, and a communication network congestion state.

The communication network data accumulated in the memory may be configured to include data collected from not only the vehicle 10 but also the other vehicle 30 in the same country or region to comprehensively reflect a regional network state. For example, a communication network in which a number of vehicles in a specific region have exhibited a connection success rate equal to or higher than a predetermined value may be included in the first communication network list. On the other hand, a communication network whose connection quality is equal to or lower than a predetermined value or to which connection failure has been repeatedly exhibited may be excluded from the first communication network list or may have a low priority.

The control unit 230 may transmit the updated first communication network list to the vehicle 10 (S950).

Specifically, the control unit 230 may transmit the updated first communication network list to the vehicle 10 in real time through the communication unit 210 or may transmit the updated first communication network list before the vehicle 10 enters a sleep mode in a state in which the power is turned off. The updated first communication network list may include information on communication networks allocated to each region The updated first communication network list may be configured to provide a communication network suitable for the vehicle 10 by reflecting a previous connection record of the vehicle and communication quality data.

Further, the control unit 230 may selectively include required communication network information based on a current location or movement route of the vehicle 10 when transmitting the first communication network list. For example, when the vehicle 10 is moving in a specific country, a list of communication network information having a connection success rate in the country equal to or higher than a predetermined value recorded therein may be created and transmitted.

The first communication network list may be stored in the storage unit 120, and may be retrieved when the vehicle 10 requests a communication connection, thereby providing a roaming environment. Further, the control unit 230 may check a memory state of the vehicle at the time of transmitting the list and record a list update record as a log in the storage unit 220 of the server 20 so that the list update record can be utilized for a subsequent list optimization task.

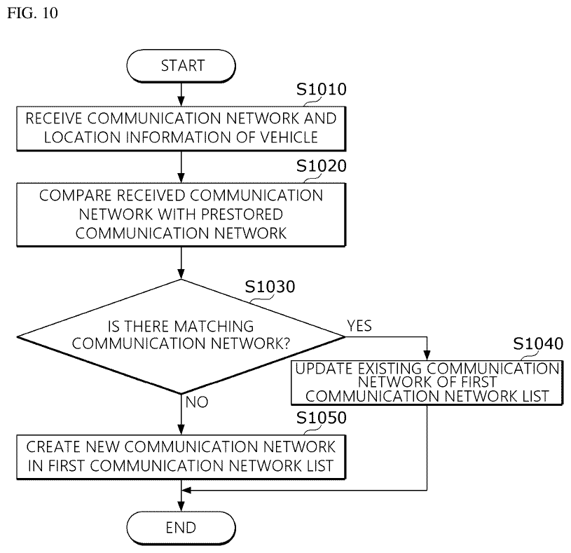

FIG. 10 is a flowchart showing the content of managing the first communication network list in the server according to an embodiment.

The control unit 230 may collect communication network information for managing the first communication network list from the vehicle 10 (S1010). The collected communication network information may include various types of data such as a current location of the vehicle, a previous connection record, communication quality, and a device state, making it possible to update the first communication network list in real time.

According to an embodiment, the collected communication network information may include at least one of connection information, basic information, state information, and performance information. Further, the location information of the vehicle may be transmitted together with the communication network information or transmitted independently as separate information.

The connection information includes a PLMN communications company, a tracking area identity (TAI: base station), an E-UTRAN cell identifier (ECI: lower cell) to which the vehicle is connected, and location information, so that a history of connection to a network used by the vehicle can be ascertained.

The basic information may include at least one of a vehicle model, a type of modem hardware (HW), and SIM profile information so that a specification of a communication device of the vehicle can be identified.

The state information may include at least one of a version of modem software (SW) and RAT information so that a state of the communication device of the vehicle can be identified.

The performance information may include various indicators indicating the quality of the communication network to which the vehicle 10 is connected. For example, the performance information may include at least one of RSRP indicating a received signal strength of an LTE network, received signal code power (RSCP) indicating a received signal strength of a WCDMA network, a received signal strength indicator (RSSI) indicating a received signal strength of a CDMA network, an SNR that is an indicator for evaluating network quality, Ec/No (signal power to noise/interference ratio of WCDMA) and Ec/Io (signal power to total interference power ratio of CDMA), and data transmission speed (download and upload).

The control unit 230 may compare the communication network corresponding to the communication network information received from the vehicle 10 with the communication network stored in the memory (S1020). For example, the control unit 230 may identify the same or similar network information by comparing information such as the location information of the communication network, PLMN, TAI, and ECI transmitted from the vehicle 10 with existing communication network data stored in the memory.

The control unit 230 may determine whether a communication network matching the received communication network information is present in the memory (S1030).

According to an embodiment, the control unit 230 may confirm whether the same or similar communication network information is stored within a reference distance at a location corresponding to the communication network information received from the vehicle 10.

According to an embodiment, the control unit 230 may confirm whether the communication network information having the same SIM information as the communication network information received from the vehicle 10 is stored. For example, the control unit 230 may confirm whether the communication network information having the same SIM information as the communication network information received from the vehicle 10 is present in the storage unit 220.

Further, the control unit 230 may confirm whether communication network information having the same modem HW information as the communication network information received from the vehicle 10 is present in the storage unit 220.

Further, the control unit 230 may confirm whether communication network information having the same modem SW information as the communication network information received from the vehicle 10 is stored.

When information indicating whether the same communication network is present within the reference distance in the surroundings, the same SIM information, the same modem HW information, and the same modem SW information as above are all absent, the control unit 230 may determine that there is no matching communication network and proceed to operation S1050. Specifically, when the communication network matching the received communication network information is not present in the memory (NO in S1030), the control unit 230 may add new communication network information to the first communication network list (S1050). This corresponds to a case in which the vehicle 10 has moved to a new area or a previously unused communication network has been detected and the control unit 230 may register a new communication network to extend the first communication network list.

When a communication network matching the communication network information received from the vehicle 10 is stored in the memory (YES in S1030), the control unit 230 may update existing communication network information of the first communication network list (S1040). For example, the control unit 230 may compare received state information (SNR, RSRP, RSSI, and the like) and performance data (download and upload speed) of the communication network with existing information stored in the memory to readjust a priority of the communication network or update information updated to reflect new performance data in the first communication network list.

For example, when there is at least one of whether the same communication network is present within the reference distance, the same SIM information, the same HW information, and the same SW information, the control unit 230 may compare such information with the existing stored communication network information to determine whether to update the communication network information.

For example, the control unit 230 may confirm whether the received communication network information supports a higher RAT than that of an existing communication network stored in a DB. When the received communication network has a higher RAT than the existing communication network in the DB, the communication network may be an update target.

For example, the control unit 230 may determine whether the received communication performance information (RSRP, SNR, Ec/No, and the like) of the communication network is superior to the existing network stored in the DB through a comparison. For example, when the received RSRP value of the communication network is higher than the existing communication network or the SNR value is superior, the control unit 230 may determine the communication network information to be updated.

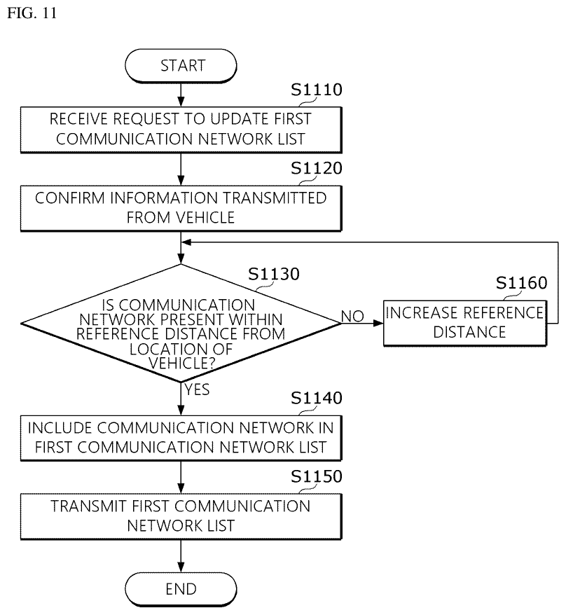

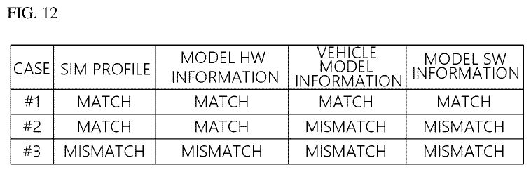

FIG. 11 is a flowchart showing the content of managing the first communication network list in the server 20 according to an embodiment. For description of FIG. 11, reference is to FIG. 12. FIG. 12 is an illustrative diagram of information that is used in a process of managing the first communication network list in the server according to an embodiment.

The control unit 230 of the server 20 may receive a request to update the first communication network list from the vehicle 10 (S1110). This request to update the first communication network list may be received after the vehicle 10 is powered off or after the vehicle 10 is powered on but is not limited to a specific point in time.

The control unit 230 may confirm information transmitted from the vehicle 10, i.e., the communication network information received from the vehicle 10 (S1120). For example, the communication network information may be received together with the location information of the vehicle 10.

According to an embodiment, the control unit 230 may confirm a transmission-required information criterion in which communication network information to be transmitted has been set depending on whether the communication network information received from the vehicle 10 matches communication network information stored in advance. Examples of such a transmission-required information criterion are illustrated in FIG. 12.

For example, in FIG. 12, only when a condition occurs in which the communication network information received from the vehicle 10 matches all of the SIM profile, the modem HW information, the vehicle model information, and the modem SW information as when criterion #1 is set as the criterion, the communication network information in which all of such elements match may be configured to be included in the first communication network list.

Further, when a condition occurs in which only some information (for example, the SIM profile and the modem HW information) matches and some information (for example, the vehicle model information and the modem SW information) does not match as when criterion #2 is set as the criterion, a plurality of communication networks corresponding to the matching information may be configured to be included in the first communication network list.

Further, when none of the information matches as in criterion #3, the most recent first communication network list stored in the storage unit 220 may be configured to be transmitted.

The control unit 230 may confirm whether the communication network is present within the reference distance from the location of the vehicle 10 in the communication network information stored in the storage unit 220 (S1130). This reference distance may be set by the user of the vehicle 10 or set automatically according to a preset policy.

When the communication network is present within the reference distance (YES in S1130), the control unit 230 may include the communication network in the first communication network list (S1140) and transmit the updated first communication network list to the vehicle 10 so that the updated first communication network list can be utilized when the vehicle 10 connects to the communication network (S1150).

On the other hand, when the communication network is not present within the reference distance (NO in S1130), the control unit 230 may increase the reference distance by a predetermined value (S1160) and repeatedly perform a step of confirming the communication network present within the reference distance again. In this case, a process of increasing the reference distance is performed step by step and may be designed so that information on surrounding communication networks is not omitted.

Although not shown, when no communication network is present within the reference distance from the location of the vehicle 10 after the reference distance is increased a predetermined number of times or more, the control unit 230 may determine that the communication network cannot be updated at the location, and end the operation of FIG. 11 or provide a notification to the user.

The term “unit” used in various embodiments refers to a software or hardware component such as a field-programmable gate array (FPGA) or an ASIC, and a “unit” performs certain operations or functions. A “unit” may be configured to reside on an addressable storage medium or may be configured to operate one or more processors. For example, the term “storage unit”, e.g., the storage unit 120, and 220, refers to a non-transitory memory configured to store data such as software, software components, object-oriented software components, class components, and task components, processes, functions, attributes, procedures, subroutines, segments of program code, drivers, firmware, microcode, circuits, data, databases, data structures, tables, arrays, and variables. Functions provided in the components and the “units” may be combined into a smaller number of components and “units” or may be further separated into additional components and “units.” In addition, the components and “units” may be implemented to operate one or more CPUs in a device or a secure multimedia card.

The embodiments of the present disclosure provide a technical solution to minimize communication network connection failure of vehicles in a roaming environment and maintain a stable network connection by providing an optimized communication network connection logic based on big data.

The effects of the present disclosure are not limited to the effects mentioned above. Other effects that have not been mentioned should be clearly understood by those of ordinary skill in the art from the description below.

Although the present disclosure has been described above with reference to various embodiments of the present disclosure, it should be understood by those of ordinary skill in the art that various modifications and changes can be made to the present disclosure without departing from the spirit and scope of the present disclosure set forth in the following claims.

What is claimed is:

1. A vehicle comprising:
a communication unit configured to communicatively connect the vehicle to a communication network or a server;
a memory configured to store a first communication network list including at least one communication network and a second communication network list including at least another communication network configured to have a restricted communication connection to the vehicle; and
a processor configured to confirm a communication connection request for connection of the vehicle to a communication network and request a communication connection to a specific communication network based on the first communication network list and based on a predetermined communication condition being satisfied,
wherein the first communication network list is configured not to be included in the second communication network list by the processor or the server.

2. The vehicle of claim 1, wherein the processor is configured to transmit communication network information including location information of the vehicle to the server based on the vehicle being powered off.

3. The vehicle of claim 1, wherein the processor is configured to receive an updated first communication network list from the server based on the vehicle being powered off or based on the vehicle being powered on after the vehicle is powered off.

4. The vehicle of claim 1, wherein the processor is configured to transmit information on the specific communication network and location information of the vehicle to the server based on the communication connection to the specific communication network being successful.

5. The vehicle of claim 1, wherein the second communication network list includes information on at least one communication network failing to establish a communication connection to the vehicle.

6. The vehicle of claim 1, wherein the predetermined communication condition includes failure of the communication unit to establish a communication connection to a previously connected communication network of the vehicle.

7. The vehicle of claim 6, wherein the predetermined communication condition further includes no communication network being previously connected.

8. The vehicle of claim 1, wherein the predetermined communication condition further includes a priority of radio access technology (RAT) of a previously connected communication network being lower than that of RAT of the communication network included in the first communication network list.

9. The vehicle of claim 1,
wherein the memory is further configured to store information on a previously connected communication network of the vehicle, and
wherein the processor is configured to
sequentially request a communication connection between the vehicle and the previously connected communication network, and
request a communication connection to the communication network included in the first communication network list based on the communication connection failing.

10. The vehicle of claim 9,
wherein the memory is further configured to store a list of public land mobile networks (PLMNs) available for each country, and
wherein the processor is configured to request a communication connection to a communication network not included in the second communication network list among communication networks included in the list of PLMNs based on the connection to the communication network included in the first communication network list failing.

11. A method for controlling connection of a vehicle to a communication network, the method comprising:
confirming a communication connection request for connection of the vehicle to the communication network; and
requesting a communication connection of the vehicle to a specific communication network based on a first communication network list and based on a predetermined communication condition being satisfied,
wherein the first communication network list and a second communication network list are stored in a memory of the vehicle,
wherein the first communication network list includes at least one communication network and the second communication network list includes at least another communication network configured to have a restricted communication connection to the vehicle, and
wherein the first communication network list is configured not to be included in the second communication network list based on a communication connection having failed between the vehicle and the communication network.

12. The method of claim 11, further comprising transmitting communication network information including location information of the vehicle to a server based on the vehicle being powered off.

13. The method of claim 11, further comprising receiving an updated first communication network list from a server based on the vehicle being powered off or based on the vehicle being powered on after the vehicle is powered off.

14. The method of claim 11, further comprising transmitting information on the specific communication network and location information of the vehicle to a server based on the communication connection to the specific communication network being successful.

15. The method of claim 11, wherein the predetermined communication condition includes at least one of:
the vehicle failing to establish a communication connection to a previously connected communication network;
no communication network being previously connected; and
a priority of radio access technology (RAT) of the previously connected communication network being lower than that of RAT of the communication network included in the first communication network list.

16. A server comprising:
a communication unit;
a memory configured to store a first communication network list including at least one communication network; and
a control unit configured to
confirm, based on a communication connection to a vehicle being successful, receipt of communication network information and location information of the vehicle from the vehicle, and
update the first communication network list based on the communication network information and the location information of the vehicle received from the vehicle and based on communication network information stored in the memory,
wherein the first communication network list includes at least one communication network configured to match the vehicle in response to receipt of a request for information on the first communication network list from the vehicle and transmit the first communication network list to the vehicle.

17. The server of claim 16, wherein the control unit is configured to:
confirm whether a location of the vehicle requesting the first communication network list is within a reference distance from a location corresponding to a prestored communication network, wherein the first communication network list includes the communication network being within the reference distance; and
transmit the first communication network list to the vehicle.

18. The server of claim 17, wherein the control unit is configured to:
determine at least one communication network of communication networks being within the reference distance based on the communication network information received from the vehicle, wherein the first communication network list includes the at least one communication network being determined to be within the reference distance; and
transmit the first communication network list to the vehicle.

19. The server of claim 18, wherein the control unit is configured to determine the at least one communication network based on at least one of a SIM profile, modem hardware information, modem software information, and modem vehicle model information of the communication network in the communication network information received from the vehicle.

20. The server of claim 17, wherein the control unit is configured to increase the reference distance when the location of the vehicle deviates from the location corresponding to the prestored communication network by the reference distance.
